(19) United States
(12) Patent Application Publication
(10) Pub. No.: US 2025/0019103 A1
(43) Pub. Date: Jan. 16, 2025

(54) Apparatus for Making Filled Film Bags

(71) Applicant: Harro Hoefliger Verpackungsmaschinen GmbH, Allmersbach im Tal (DE)

(72) Inventors: Matthias Messerschmid, Allmersbach im Tal (DE); Tobias Augustin, Allmersbach im Tal (DE)

(21) Appl. No.: 18/773,159

(22) Filed: Jul. 15, 2024

(30) Foreign Application Priority Data
Jul. 14, 2023 (EP) 23185673.3

(51) Int. Cl. B65B 9/04; B65B 57/02; G01N 21/90

(52) U.S. Cl. CPC B65B 9/04; B65B 57/02; G01N 21/9081

(57) ABSTRACT

An apparatus is for producing filled film bags. The apparatus includes plate elements, each having at least one mold recess, a first processing station with a deep-drawing arrangement for deep-drawing a base film into the mold recesses to form filling cavities, a second processing station with a filling arrangement for filling the filling cavities with a filling substance, and a third processing station with a sealing arrangement for sealing a cover film onto the base film while respectively forming a continuous circumferential seal edge around each of the filling cavities. The third processing station is followed by a fourth processing station with a testing device for optical acquisition and quality assessment of the seal edge. The testing device includes an optical camera, means for increasing the contrast of the images recorded by the camera, an illumination device, and an evaluation unit for the images recorded by the camera.

### CROSS-REFERENCE TO RELATED APPLICATIONS

This application claims priority of European patent application no. 23185673.3, filed Jul. 14, 2023, the entire content of which is incorporated herein by reference.

### BACKGROUND

In many fields of application, particularly for the household, film bags are increasingly being used, for example with laundry or dishwashing detergents as content. Such film bags are widely manufactured from a water-soluble film material such as PVOH (polyvinyl alcohol), which dissolves and releases the content upon contact with water.

A typical production apparatus for such film bags includes plate elements with mold recesses, which can be conveyed to various processing stations. In a first processing station with a deep-drawing arrangement, a base film is initially deep-drawn into the mold recesses so that filling cavities are formed in the base film. These filling cavities are filled with a filling substance in a subsequent second processing station. This is followed by a third processing station with a sealing arrangement. There, a cover film is sealed onto the base film while respectively forming a continuous circumferential seal edge around each of the filling cavities. Lastly, individual film bags are separated and singulated from a web sealed in such a way.

The quality of the seal edge is of particular importance. Even small sealing defects, for example due to filling substance lying in between, may cause a leak of the product which leads to undesired after-effects of contamination of the filling machine and may result in unusable retail packaging.

### SUMMARY

It is an object of the disclosure to further develop an apparatus of the type mentioned above in such a way that the quality of the finished seal edge can be assessed reliably during ongoing operation.

This object is, for example, achieved by an apparatus for producing filled film bags. The apparatus includes: a plurality of processing stations including a first processing station, a second processing station, a third processing station and a fourth processing station; a plurality of plate elements configured to be conveyed to various ones of the plurality of processing stations; each of the plurality of plate elements having a mold recess; the first processing station having a deep-drawing arrangement for deep-drawing a base film into the mold recesses of the plurality of plate elements in order to form filling cavities in the base film; the second processing station having a filling arrangement for filling the filling cavities with a filling substance; the third processing station having a sealing arrangement for sealing a cover film onto the base film while respectively forming a continuous circumferential seal edge around each of the filling cavities; the third processing station being followed by the fourth processing station; the fourth processing station having a testing device for optical acquisition and quality assessment of the continuous circumferential seal edge; the testing device including an optical camera, an illumination device, and an evaluation unit for images recorded by the optical camera; the testing device further including a contrast adjuster for increasing a contrast of images recorded by the camera; the contrast adjuster includes a polarization filter of the illumination device and a configuration of the camera as a polarization camera, wherein a polarization direction of the polarization filter is aligned at a polarization angle with respect to a movement direction of the plurality of plate elements; and, the polarization angle lies in a range of 30° to 60°.

According to the disclosure, the third processing station with the sealing arrangement is followed by a fourth processing station with a testing device for optical acquisition and quality assessment of the seal edge. The testing device includes an optical camera, means for increasing the contrast of the images recorded by the camera, an illumination device, and an evaluation unit for the images recorded by the camera.

The disclosure allows in particular 100% in-line process control as to whether the seal edges generated have a sufficient quality and therefore leak-tightness. The camera acquires the sealed film webs in the region of one or more film bags and makes one or more images thereof. The contrast adjuster/means for increasing the contrast influence the recorded image in such a way that clear distinction is possible between the seal edge, possible faults in the seal edge and the other regions of the film bag, for example the filling cavity and the filling contained therein. Electronic image recognition or image evaluation is then carried out in the evaluation unit via a suitable algorithm. With the aid of the evaluation result, it is possible to establish whether there is a sufficient quality of the seal edge. If this is not the case, the corresponding film bag may be removed after the separation and disposed of. Overall, the desired leak-tightness of the film bags may be ensured with a high process reliability.

In an embodiment, the means for increasing the contrast include a reflection-reducing surface of the plate elements. The reduction of the reflection may, for example, be achieved by a matte finish of the otherwise polished metal surface. In particular, the reflection-reducing surface is formed by blackening of the surface. In practice, it has been found that particularly good distinction between a correct seal edge and possible faults therein is thereby possible.

In a variant, the contrast adjuster or means for increasing the contrast includes a polarization filter of the illumination device and a configuration of the camera as a polarization camera. This variant is based on the discovery that, owing to their production process by extrusion and/or blow molding, films have a more or less pronounced preferential direction which becomes evident in the process of sealing. During partial dissolving of the film surface, particularly during wet sealing, the aforementioned preferential direction leads in polarized light under particular circumstances to the clear appearance of fully or insufficiently sealed locations. The achievable contrasts are so good that a quality assessment is under certain circumstances possible even without a cost-intensive reflection-reducing surface of the plate elements.

In an embodiment, a polarization direction of the polarization filter is aligned at a polarization angle with respect to a movement direction of the plate elements, the polarization angle preferentially lying in a range of from 30° to 60°, and being in particular 45°. This takes account of the fact that the film webs generally have a preferential direction which is predefined by their longitudinal direction and in turn corresponds to the movement direction of the plate elements. The aforementioned polarization angle leads under these conditions to a pronounced contrast increase and therefore to the possibility of reliable quality assessment.

In an embodiment, the plate elements are provided with a marking for identifying the placement of the seal edge. This is based on the discovery that the achievable contrasts per se are not always sufficient in order to distinguish the seal edge from other parts of the image, for example the filling cavity and the filling substance contained therein. With the aid of a suitable marking, however, the image may be brought by virtual rotation and displacement into congruence with the actual container geometry. This makes it possible to assign particular image contrasts uniquely to the seal edge to be examined, which increases the possibility of reliable quality assessment.

In an embodiment, the camera is a line scan camera. An image line is in this case transverse with respect to the movement direction of the plate elements. The movement of the plate elements leads to an image composition from a multiplicity of such image lines, a high image resolution being achievable. A cycled interruption of the plate forward feed merely for the imaging is not necessary, which simplifies the integration of the optical sealed seam control into the rest of the production process. Parallax errors in the imaging are reduced to a minimum. Furthermore, only relatively simple requirements for the image lighting need to be taken into account since differences of the illumination intensity in the movement direction are of no concern.

The line scan camera only records a single image line at a time in rapid succession. In order to obtain a two-dimensional image from such image lines, the succession of image lines must be set in relation to a movement of the format plates. In one common configuration, the format plates are moved as an endless chain on a circulating path via a servomotor. Such a servomotor may output its current position to the camera system and could therefore function as an encoder for the format plate movement. It has, however, been found that the actual movement of the format plates at the site of the camera is not always sufficiently uniform and does not correlate with the drive movement of the servomotor. This is because various perturbations affect the plate transport. On the one hand, nonuniform stretching of the chain links of the transport chain is to be observed. On the other hand, the format plates are pulled via a vacuum channel, which leads to high static friction and jolting position changes during the acceleration and stopping of the transport. The aforementioned effects are strongest in the middle of the machine (total length about 18 m), that is, approximately at the location where the camera is mounted.

In an embodiment, a separate encoder is therefore arranged in the region of the line scan camera in order to acquire the movement of the plate elements. The aforementioned nonuniformities of the plate movement may jointly be taken into account in this way, so that exact synchronization can be achieved between the plate movement and the recording sequence of the line scan camera.

The encoder fitted at the aforementioned location may be provided with a wheel that rolls on the plate elements or with other means for acquisition of the movement. It has however been found that under real production conditions, for example when filling with powdered and/or liquid laundry detergent, contamination of the format plate may occur to the extent that unimpeded rolling cannot be ensured with sufficient reliability. Advantageously, therefore, the encoder is provided with a contactless sensor and in particular with a laser sensor for acquisition of the movement of the plate elements. By using the Doppler effect, for example, both a nonuniform behavior of the drive train may be taken into account and negative influences due to contamination may be excluded. Exact acquisition of the movement, and consequently exact synchronization of the recording sequence of the line scan camera with the movement of the plate, are possible even under harsh production conditions.

Alternatively, it may be expedient for the camera to be an area scan camera. A complete image of the area to be tested may in this case be obtained in a very short time with simple means without outlay on synchronization.

In an embodiment, the illumination device is embodied as a strip light which is arranged transversely with respect to a movement direction of the plate elements. In this way, uniform lighting may be achieved at least transversely with respect to the aforementioned movement direction, which is desired particularly in combination with a line scan camera. Furthermore, the strip light also constitutes a good basis for a polarization filter and therefore for image lighting with polarized light.

In an alternative, the illumination device includes an illumination dome which spans the plate elements in the region of the camera. The illumination dome allows indirect image lighting by diffuse light with a high uniformity, which is desired particularly in combination with an area scan camera.

### BRIEF DESCRIPTION OF DRAWINGS

The invention will now be described with reference to the drawings wherein:

FIG. 1 shows a schematic overview representation of an apparatus according to the disclosure for producing filled film bags with a deep-drawing arrangement, a filling arrangement, a sealing arrangement and an optical testing device;

FIG. 2 shows a schematic plan view of the arrangement according to FIG. 1 in the region of the testing device with an illumination device embodied as a strip light and with a line scan camera;

FIG. 3 shows a schematic plan view of a film bag produced via the apparatus according to FIGS. 1 and 2 with a circumferential seal edge;

FIG. 4 shows a side view of a variant of the arrangement according to FIGS. 1 and 2 with an illumination device including an illumination dome and with an area scan camera;

FIG. 5 shows a schematic front view of a variant of the arrangement according to FIGS. 1 and 2 with a polarizing filter arranged in front of the strip light at a polarization angle of 45°;

FIG. 6 shows a schematic perspective view of a detail of the image sensor of the line scan camera according to FIGS. 1 and 2 in an optional embodiment as a polarization camera; and,

FIG. 7 shows a schematic plan view of a detail of the image sensor of the area scan camera according to FIG. 4 in an optional embodiment as a polarization camera.

### DETAILED DESCRIPTION

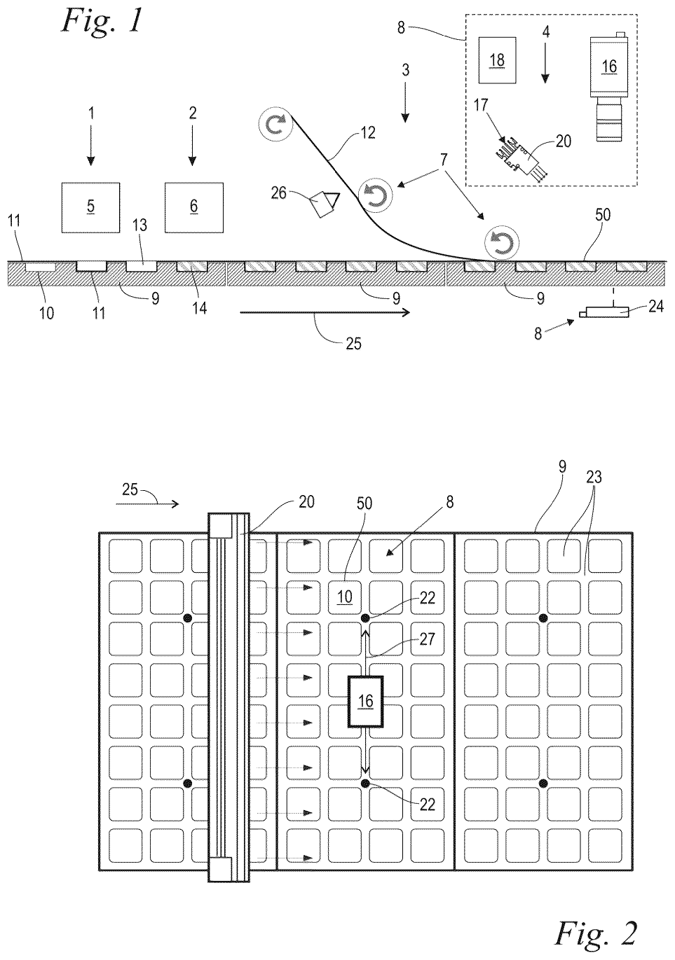

FIG. 1 shows a schematic overview representation of an apparatus according to the disclosure for producing filled film bags 50. The film bags 50 are produced from a deep-drawn base film 11 with filling cavities 13, from a filling substance 14 with which the filling cavities 13 are filled, and from a cover film 12 that is applied by sealing. In the scope of the disclosure, any desired film materials may be used. In the present case, the base film 11 and the cover film 12 are water-soluble films, in particular of PVA (polyvinyl alcohol). The filling substance 14 may be selected freely in the scope of the disclosure. In the present case, it is a laundry detergent or dishwashing detergent in the form of a powder and/or liquid.

The apparatus includes a series of processing stations, a selection of which with a first processing station 1, a second processing station 2, a third processing station 3 and a fourth processing station 4 is schematically indicated here. A multiplicity of plate elements 9 are connected together to form a continuous chain. During operation, this chain is driven continuously and circumferentially by a drive (not represented). For better clarity, only a detail of the upper chain section in the height direction is shown here, which in the image is conveyed continuously from left to right in a movement direction 25 successively to the various processing stations 1, 2, 3, 4. Intermittent operation may, however, also be provided. After the manufacture of the film bags, the plate elements 9, which are then empty, are returned (in a manner not represented) as a lower chain section below the upper chain section represented here in a continuous circulating path to the starting position.

A comparison with FIG. 2 reveals that the individual plate elements 9 each have a plurality of mold recesses 10 arranged in the form of a matrix. For the sake of simplicity, the mold recesses are represented here schematically with a square outline and with rounded corners. In practice, any desired other outlines are selected, and a plurality of mold recesses 10 for a plurality of different filling substances 14 may respectively be combined in groups for an individual film bag 50.

First, the base film 11 is placed flat on the plate elements 9. The first processing station 1 represented here includes a deep-drawing arrangement 5 (only indicated in a block representation). With the latter, the base film 11 is heated to plasticization and then deep-drawn into the mold recesses 10 of the plate elements 9 via a vacuum. Filling cavities 13 are thereby formed in the base film 11. The plate elements 9 are subsequently guided further together with the deep-drawn base film 11 to the second processing station 2, which includes a filling arrangement 6 (only indicated in a block representation). Via the filling arrangement 6, the filling cavities 13 are filled with measured portions of the aforementioned filling substance 14. In the following processing step, the plate elements 9 together with the deep-drawn base film 11 and the filling substance 14 that has been introduced pass through the third processing station 3 with a sealing arrangement 7 (only indicated in a block representation). There, the cover film 12 is (optionally) wetted via a wetting device 26 on its lower side, which faces toward the base film 11, placed on the base film 11 and then sealed there under the effect of pressure and (optionally) temperature.

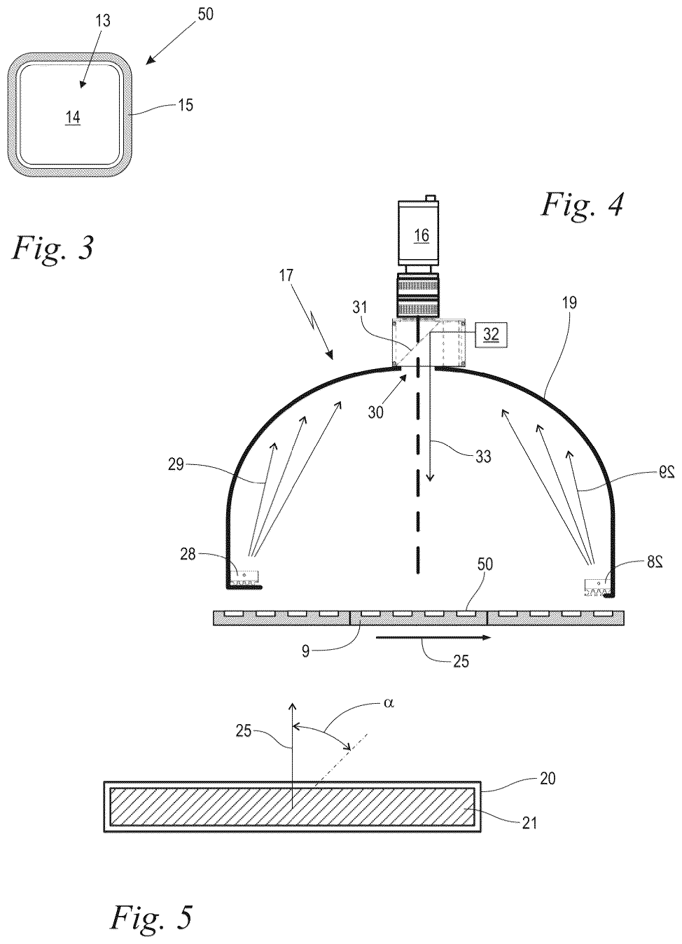

This creates a web of a multiplicity of contiguous film bags 50, which are singulated at the end (in a manner not represented) to form units ready for use. Such a film bag 50 is shown schematically in a plan view in FIG. 3. Accordingly, with the individual film bags 50 still contiguous, the sealing arrangement 7 (FIG. 1) generates a continuous circumferential seal edge 15, at which the cover film 12 is tightly connected to the base film 11, around each of the filling cavities 13 filled with the filling substance 14.

According to the disclosure, the third processing station 3 is followed in the movement direction 25 by a fourth processing station 4 with a testing device 8 (represented schematically as a block) for optical acquisition and quality assessment of the seal edge 15. The testing device 8 includes an optical camera 16, which is aimed at the web of contiguous film bags 50 still located in the mold recesses 10 of the plate elements 9. The testing device 8 further includes means for increasing the contrast of the images recorded by the camera 16, an illumination device 17, and an evaluation unit 18 for the images recorded by the camera 16, as will be described in more detail below.

The testing device 8 is spatially static, while the chain of plate elements 9 together with the web of contiguous film bags 50 still located in the mold recesses 10 of the plate elements 9 are moved past it in a continuous movement in the movement direction 25.

FIG. 2 shows a schematic plan view of the arrangement according to FIG. 1 in the region of the testing device 8. In the embodiment shown, the camera 16 is embodied as a line scan camera and is adapted in such a way that, with a single instantaneous recording, it creates an image line of the film bags 50 located in the mold recesses 10, which extends transversely with respect to the movement direction 25 and therefore according to a double arrow 27 transversely over the entire width of the plate elements 9. The camera 16 generates a multiplicity of such image lines in rapid succession. These image lines are fed to the evaluation unit 18.

Besides the camera 16, an encoder 24 for acquisition of the movement of the plate elements 9 is also connected to the evaluation unit 18. In relation to the movement direction 25, the encoder 24 is arranged in the region or immediate vicinity of the camera 16, and is arranged below the plate elements 9 in the height direction. The encoder 24 is provided with a contactless sensor, here with a laser sensor for acquisition of the movement of the plate elements 9 via the Doppler effect. The acquired movement data are fed to the evaluation unit 18.

Because of the immediate proximity of the encoder 24 to the camera 16, the movement of the plate elements 9 which is acquired by it corresponds exactly to the movement that leads to different image lines in the spatially stationary camera 16. In the evaluation unit 18, the different image lines are synchronized with the acquired movement data of the plate elements 9 in such a way that a composite distortion-free 2D image of the film bags 50 located in the mold recesses 10, including their seal edges 15 (FIG. 3), is obtained from the image lines.

A quality assessment based thereon, which is preferably likewise performed automatically in the evaluation unit, in particular of the seal edges 15 (FIG. 3), assumes uniform illumination. Since the camera 16 records image lines transversely with respect to the movement direction 25, only uniformity of the illumination in this transverse direction is important in the present case. Consequently, the illumination device 17 is embodied as a strip light 20 which is arranged transversely with respect to the movement direction 25 while spanning the plate elements 9 over their entire width.

As a further measure for reliable quality assessment, the means already mentioned in the introduction for increasing the contrast of the images recorded by the camera 16 are provided. For this purpose, in the present case a surface 23 of the plate elements 9 that faces toward the camera 16 is provided with a reflection-reducing treatment. This may involve a matte or satin finish instead of a metallically polished surface 23. In the embodiment shown, this surface 23 is blackened overall, that is, inside the mold recesses 10 and also in between in the region of the seal edges 15 (FIG. 3). At selected locations, this blackening is interrupted by circular milled portions in order to form markings 22 for identifying the placement of the seal edges 15 (FIG. 3), particularly in distinction from the mold recesses 10. Accordingly, unlike the rest of the blackening, the markings 22 are bright, or metallically polished. For better legibility of the drawing, a negative representation is selected in FIG. 2, in which the bright markings 22 are represented as being dark and the remaining blackened regions of the surface 23 represented as being bright.

The markings 22 are configured in such a way that unequivocal determination of the placement is possible within all degrees of freedom of the plane of the image, or the plane of the plate. For example, it may be a cross or another geometrical figure. In the present case, a pair of circular point-like areas has been selected for each plate element 9. In any event, a virtual displacement of the image recorded by the camera 16 in the movement direction 25, a virtual displacement in the lateral direction running transversely with respect thereto according to the double arrow 27, and a virtual rotation about a height axis perpendicular to both directions, may thereby be carried out in the evaluation unit 18 in such a way that the recorded image is brought into congruence with an existing target geometry. In this way, those regions of the seal edges that are to be tested may be distinguished unequivocally from other regions, for example the regions of the mold recesses 10 with the filling cavities 13 and the filling substance 14.

The images with their contrast increased as described above allow in particular automated assessment of the quality of the seal edges 15. Contamination enclosed during the sealing, in particular due to filling substance 14, undesired creases in the film material or other faults of the seal edges may be identified clearly. Correspondingly faulty individual film bags may subsequently be removed. In the event of an increased error rate, the production process may also be interrupted in order to eliminate the error. At least, consequential damage due to leaking film bags may reliably be avoided or at least reduced to a minimum.

FIG. 4 shows a side view of a variant of the arrangement according to FIGS. 1 and 2, in which the camera 16 is embodied as an area scan camera. Unlike the line scan camera according to FIGS. 1 and 2, the area scan camera records a complete two-dimensional image of the web of film bags in a single recording, this image extending both in the movement direction 25 and transversely with respect thereto (double arrow 27 in FIG. 2). An encoder 24 as in FIG. 2 is not necessary here. For reliable image evaluation, however, it is necessary to ensure uniform lighting of the entire image field not only in the transverse direction (double arrow 27 in FIG. 2) but also in the movement direction 25. For this, the illumination device 17 in the arrangement according to FIG. 4 includes an illumination dome 19 which fully covers the image region of the area scan camera. The image region is preferably at least as large as the base area of an individual plate element 9.

On its edges facing toward the plate elements 9, the illumination dome 19 is provided with lighting means 28 which are not aimed directly at the plate elements 9 but which light the inner side of the illumination dome 19 according to arrows 29. The inner side of the illumination dome 19 is provided with a surface which diffusely reflects the light of the lighting means 28 and thereby lights the upper side of the plate elements 9 that faces toward the camera 16 with a uniform intensity.

At the upper apex of the illumination dome 19, it has an image opening 30 above which the camera 16 is mounted. Through this image opening 30, the camera records images of the plate elements 9 located underneath with the still contiguous film bags 50 contained therein.

Between the camera 16 and the image opening 30, there is also a semitransparent mirror 31 set obliquely at 45°. The semitransparent mirror 31 allows the above-described image recording through itself via the camera 16. In addition, light of a further lighting means 32 is introduced into the interior of the illumination dome 19 by the semitransparent mirror. This compensates for the missing reflection of the light of the lower lighting means 28 at the image opening 30, so that lighting of the image field with a uniform intensity is achieved overall.

Unless otherwise described, the embodiment according to FIG. 4 corresponds in the other features and reference signs to the embodiment according to FIGS. 1 to 3.

A further inventive concept of the means for increasing the contrast of the images recorded by the camera 16 is represented in FIGS. 5 to 7. In this case, the means for increasing the contrast include a polarization filter 21 of the illumination device 17 and a configuration of the camera 16 as a polarization camera. A comparison with FIGS. 1 and 2 reveals a variant of the arrangement shown there, in which the strip light 20 is provided with a polarization filter 21 (indicated schematically in FIG. 5) in front. The polarization filter 21 polarizes the light emerging from the strip light 20 at a polarization angle α relative to the movement direction 25. The polarization angle α advantageously lies in a range of from 30° to 60°, and in the embodiment shown is about 45°. Accordingly, the web of contiguous film bags 50 (FIG. 1) is illuminated with light polarized in this direction.

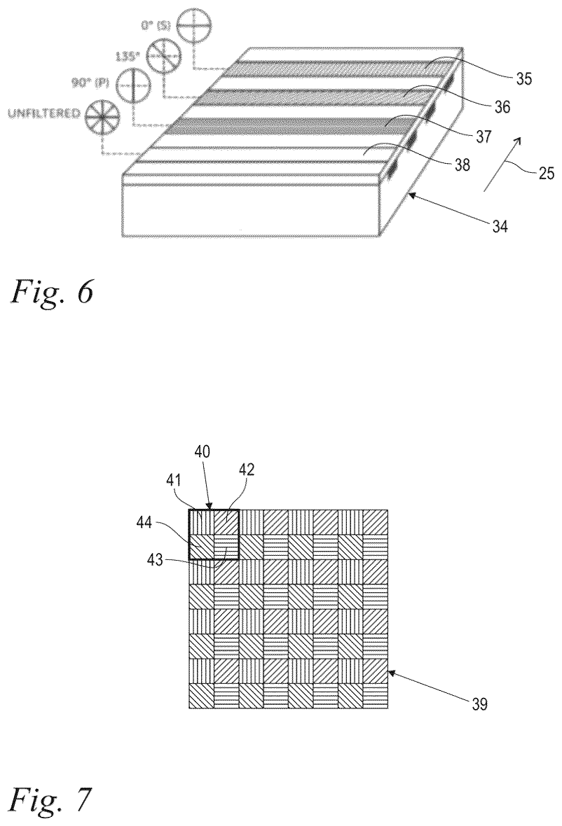

The camera 16 embodied according to FIG. 1 as a line scan camera is embodied in the variant described here as a polarization camera. An associated image sensor 34 of such a line scan camera embodied as a polarization camera is shown schematically in FIG. 6 and includes in total four sensor strips 35, 36, 37, 38 running transversely with respect to the movement direction 25 with different filters for different polarization states. A first sensor strip 35 records image components with a polarization angle α=0°. A second sensor strip 36 records image components with a polarization angle α=135°. A third sensor strip 37 records image components with a polarization angle α=90°. Furthermore, a fourth sensor strip 38 is set up without a polarizing filter and records unfiltered image signals. A resulting image line may be generated according to its actual polarization state from the image line signals of all four sensor strips 35, 36, 37, 38.

Alternatively, instead of the line scan camera, an area scan camera embodied as a polarization camera may also be employed. A detail of an associated image sensor 39 is represented schematically in FIG. 7. Accordingly, the image sensor 39 has individual sensor pixels 40, each of which is composed of four partial pixels 41, 42, 43, 44. Each partial pixel 41, 42, 43, 44 is preceded by a polarization filter with a different polarization direction. A first partial pixel 41 records image components with a polarization angle α=0°. A second partial pixel 42 records image components with a polarization angle α=135°. A third partial pixel 43 records image components with a polarization angle α=90°. Furthermore, a fourth partial pixel 44 records image components with a polarization angle α=45°.

Both aforementioned variants of a polarization camera may be used in the scope of the disclosure in an apparatus according to FIGS. 1 and 2 together with polarized illumination according to FIG. 5. This is because, owing to their production process, the two film webs 11, 12 have a preferential direction which influences the polarization direction of the incident and then reflected light. Image contrasts are increased by the modification of the polarization state, particularly in the region of the seal edges 15 (FIG. 3), to such an extent that errors in the seal edges can readily be identified, and under certain circumstances contrast-increasing but cost-intensive blackening or another treatment of the surface 23 (FIG. 2) may be obviated. The other features and reference signs may be adopted individually or as a whole without changes.

It is understood that the foregoing description is that of the preferred embodiments of the invention and that various changes and modifications may be made thereto without departing from the spirit and scope of the invention as defined in the appended claims.

1-10. (canceled)

11. An apparatus for producing filled film bags, the apparatus comprising:
a plurality of processing stations including a first processing station, a second processing station, a third processing station and a fourth processing station;
a plurality of plate elements configured to be conveyed to various ones of said plurality of processing stations;
each of said plurality of plate elements having a mold recess;
said first processing station having a deep-drawing arrangement for deep-drawing a base film into said mold recesses of said plurality of plate elements in order to form filling cavities in the base film;
said second processing station having a filling arrangement for filling the filling cavities with a filling substance;
said third processing station having a sealing arrangement for sealing a cover film onto the base film while respectively forming a continuous circumferential seal edge around each of the filling cavities;
said third processing station being followed by said fourth processing station;
said fourth processing station having a testing device for optical acquisition and quality assessment of the continuous circumferential seal edge;
said testing device including an optical camera, an illumination device, and an evaluation unit for images recorded by said optical camera;
said testing device further including a contrast adjuster for increasing a contrast of images recorded by said camera;
said contrast adjuster includes a polarization filter of said illumination device and a configuration of said camera as a polarization camera, wherein a polarization direction of said polarization filter is aligned at a polarization angle with respect to a movement direction of said plurality of plate elements; and,
said polarization angle lies in a range of 30° to 60°.

12. The apparatus of claim 11, wherein said contrast adjuster includes a reflection-reducing surface of said plurality of plate elements.

13. The apparatus of claim 12, wherein said reflection-reducing surface is formed by blackening of a surface of said contrast adjuster.

14. The apparatus of claim 11, wherein said polarization angle is 45°.

15. The apparatus of claim 11, wherein said plurality of plate elements are provided with a marking for identifying a placement of the continuous circumferential seal edge.

16. The apparatus of claim 11, wherein said camera is a line scan camera.

17. The apparatus of claim 16 further comprising an encoder for acquisition of a movement of said plurality of plate elements; and, said encoder being arranged in a region of said line scan camera.

18. The apparatus of claim 17, wherein said encoder is provided with a contactless sensor.

19. The apparatus of claim 18, wherein said contactless sensor is a laser sensor for acquisition of the movement of said plurality of plate elements.

20. The apparatus of claim 11, wherein said camera is an area scan camera.

21. The apparatus of claim 11, wherein said illumination device is a strip light arranged transversely with respect to the movement direction of said plurality of plate elements.
